(19) United States
(12) Patent Application Publication
(10) Pub. No.: US 2025/0205992 A1
(43) Pub. Date: Jun. 26, 2025

(54) FIBER STRUCTURE

(71) Applicants: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(72) Inventors: Masaya EBINA, Kariya-shi (JP); Osamu SAWAI, Okazaki-shi (JP)

(73) Assignees: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(21) Appl. No.: 18/847,025

(22) PCT Filed: Mar. 8, 2023
(86) PCT No.: PCT/JP2023/008889

§ 371 Date: Sep. 13, 2024

(30) Foreign Application Priority Data
Mar. 22, 2022 (JP) 2022-045492

(51) Int. Cl. B32B 5/02; B32B 1/00; B32B 3/04; B32B 5/10; B32B 15/14; B32B 15/20; B32B 27/12; F17C 1/06

(52) U.S. Cl. CPC B32B 5/024; B32B 1/00; B32B 3/04; B32B 5/10; B32B 15/14; B32B 15/20; B32B 27/12; F17C 1/06; B32B 2250/02; B32B 2260/021; B32B 2260/046; B32B 2262/148; B32B 2439/40; F17C 2201/0109; F17C 2203/0619; F17C 2203/067; F17C 2209/2154; F17C 2221/012; F17C 2260/011; F17C 2260/012

(57) ABSTRACT

A fiber structure includes a liner and a fiber-reinforced base member. The liner includes a cylindrical body portion, a dome portion, and a shoulder portion. The fiber-reinforced base member covers the liner from outside. The fiber-reinforced base member includes first yarns arranged such that yarn main axes extend in the axial direction, and second yarns arranged such that yarn main axes extend in a circumferential direction of the liner. The fiber-reinforced base member includes a first section covering at least a boundary between the body portion and the dome portion, and a second section that is a section excluding the first section. An average degree of interlacing between the first yarns and the second yarns is lower in the first section than in the second section.

### TECHNICAL FIELD

The present disclosure relates to a fiber structure.

### BACKGROUND ART

For example, a fiber structure described in Patent Literature 1 includes a liner and a fiber-reinforced base member that covers the liner from the outside. The liner includes a cylindrical body portion and dome portions. Each dome portion is continuous with the body portion in an axial direction in which a central axis of the body portion extends, and has a shape tapering toward the central axis. The fiber-reinforced base member includes first yarns and second yarns. The first yarns are arranged such that the yarn main axes extend in the axial direction. The second yarns are arranged such that the yarn main axes extend in a circumferential direction of the liner.

### CITATION LIST

### Patent Literature

Patent Literature 1: Japanese Patent No. 6729472

### SUMMARY OF INVENTION

### Technical Problem

Such a fiber structure may be used as, for example, a pressure vessel filled with hydrogen gas for a fuel cell electric vehicle. When the pressure vessel is filled with hydrogen gas, an internal pressure acts on the liner, so that a load is applied to the liner. Since the magnitude of the applied load and the direction of the applied load are different between the body portion and the dome portions, the liner is likely to be distorted at the boundary between the body portion and each dome portion. The fiber-reinforced base member includes first sections covering regions including the boundary between the body portion and the dome portions, and second sections that are sections excluding the first sections. Since distortion is likely to occur at the boundary between the body portion and each dome portion, the fiber-reinforced base member is more likely to be affected by distortion of the liner in the first sections than in the second sections. When distortion occurs in a first section, the strength of the fiber structure decreases.

Therefore, the strength of the fiber structure may be increased by increasing the thickness of the entire fiber-reinforced base member. However, an increase in the thickness of the entire fiber-reinforced base member is increased unnecessarily increases the thickness of the second sections, which are less likely to be distorted than the first sections and thus do not need to be increased in strength. As a result, the weight of the fiber structure is increased unnecessarily. Also, the manufacturing costs increase unnecessarily.

### Solution to Problem

In one aspect of the present disclosure, a fiber structure includes a liner and a fiber-reinforced base member. The liner that includes a cylindrical body portion, a dome portion, and a shoulder portion. The dome portion is continuous with the body portion in an axial direction in which a central axis of the body portion extends. The dome portion has a shape tapering toward the central axis. The shoulder portion is a part of the dome portion and is an area adjacent to the body portion. The fiber-reinforced base member covers the liner from outside. The fiber-reinforced base member includes first yarns arranged such that yarn main axes extend in the axial direction, and second yarns arranged such that yarn main axes extend in a circumferential direction of the liner. The fiber-reinforced base member includes a first section and a second section. The first section extends between the shoulder portion and the body portion so as to cover at least a boundary between the body portion and the dome portion. The second section is a section excluding the first section. An average degree of interlacing between the first yarns and the second yarns is lower in the first section than in the second section.

In another aspect of the present disclosure, a fiber structure includes a liner and a fiber-reinforced base member. The liner that includes a cylindrical body portion, a dome portion, and a shoulder portion. The dome portion is continuous with the body portion in an axial direction in which a central axis of the body portion extends. The dome portion has a shape tapering toward the central axis. The shoulder portion is a part of the dome portion and is an area adjacent to the body portion. The fiber-reinforced base member covers the liner from outside. The fiber-reinforced base member includes first yarns arranged such that yarn main axes extend in the axial direction, and second yarns arranged such that yarn main axes extend in a circumferential direction of the liner. The fiber-reinforced base member includes a first section and a second section. The first section extends between the shoulder portion and the body portion so as to cover at least a boundary between the body portion and the dome portion. The second section is a section excluding the first section. The first section is provided with a reinforcing member including reinforcement fibers arranged such that yarn main axes extend in the axial direction.

### BRIEF DESCRIPTION OF DRAWINGS

FIG. 1 is a cross-sectional view schematically showing a high-pressure tank according to a first embodiment.

FIG. 2 is a side view schematically showing a fiber structure.

FIG. 3 is a front view schematically showing a part of a second section of the fiber structure shown in FIG. 2.

FIG. 4 is a front view schematically showing a part of a first section of the fiber structure shown in FIG. 2.

FIG. 5 is a cross-sectional view schematically showing a part of the high-pressure tank shown in FIG. 1.

FIG. 6 is a cross-sectional view schematically showing a high-pressure tank according to a second embodiment.

FIG. 7 is a cross-sectional view schematically showing a part of the high-pressure tank shown in FIG. 6.

FIG. 8 is a cross-sectional view schematically showing a part of a high-pressure tank according to another embodiment.

FIG. 9 is a cross-sectional view schematically showing a part of a high-pressure tank according to another embodiment.

FIG. 10 is a side view schematically showing a fiber structure according to another embodiment.

FIG. 11 is a cross-sectional view schematically showing a part of a high-pressure tank according to another embodiment.

### DESCRIPTION OF EMBODIMENTS

### First Embodiment

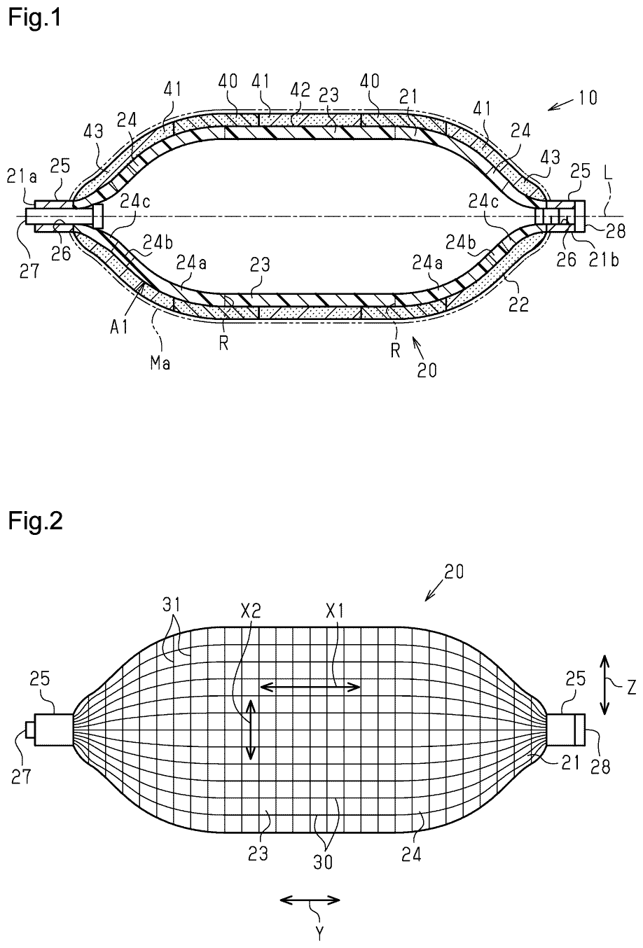

A first embodiment of the present disclosure will now be described with reference to FIGS. 1 to 5. The fiber structure described below is used for a high-pressure tank, which is a pressure vessel. The high-pressure tank is mounted on, for example, a fuel cell electric vehicle using a fuel cell as a power source. The high-pressure tank stores hydrogen gas as a fuel for the fuel cell.

### Overall Configuration of Fiber Structure 20

As shown in FIG. 1, a high-pressure tank 10 is formed by impregnating a fiber structure 20 with a matrix resin Ma. The fiber structure 20 includes an elongated hollow liner 21 and a fiber-reinforced base member 22. The fiber-reinforced base member 22 covers the liner 21 from the outside. The fiber-reinforced base member 22 covers the liner 21 from the outside to reinforce the liner 21. This ensures the pressure resistance (mechanical strength) of the high-pressure tank 10.

### Configuration of Liner 21

The liner 21 is made of plastic. A direction in which a central axis L of the liner 21 extends is defined as an axial direction Y. The liner 21 includes a cylindrical body portion 23. The central axis of the body portion 23 agrees with the central axis L of the liner 21. The liner 21 includes dome portions 24 at the opposite ends in the axial direction in which the central axis of the body portion 23 extends. The liner 21 includes a boundary R between the body portion 23 and each dome portion 24. The boundaries R are each located at a position where the outer diameter of the liner 21 starts to decrease in the direction from the body portion 23 toward the corresponding dome portion 24.

Each dome portion 24 is continuous with the body portion 23 in the axial direction of the body portion 23. Each dome portion 24 has a shape tapering toward the central axis of the body portion 23. The axial direction of each dome portion 24 agrees with the axial direction of the liner 21. Each dome portion 24 includes a first curved portion 24a, a linear portion 24b, and a second curved portion 24c. The first curved portion 24a is a portion connected to the body portion 23. The first curved portion 24a extends between the boundary R and the linear portion 24b. A first end of the linear portion 24b is connected to the first curved portion 24a. A second end of the linear portion 24b is connected to the second curved portion 24c. Therefore, the linear portion 24b extends between the first curved portion 24a and the second curved portion 24c. The second curved portion 24c extends so as to taper from the second end of the linear portion 24b. The second curved portion 24c is connected to a ferrule 25. The first curved portion 24a occupies, for example, 50% of the dome portion 24. For example, 50% of the length in the axial direction of the dome portion 24 is the length in the axial direction of the first curved portion 24a.

The liner 21 includes shoulder portions A1. In the present embodiment, the entire first curved portion 24a of each dome portion 24 is the shoulder portion A1. The shoulder portion A1 refers to a portion of the dome portion 24 that extends from the boundary R so as to taper in a curving manner. The shoulder portion A1 is an end region of each dome portion 24 adjacent to the body portion 23. Further, the shoulder portion A1 refers to a portion of the dome portion 24 from the boundary R to the central portion of the dome portion 24 in the axial direction.

The liner 21 includes the ferrule 25 at the distal end of each dome portion 24. Each ferrule 25 protrudes outward in the axial direction from the corresponding dome portion 24. The ferrules 25 are made of metal. The ferrules 25 are made of, for example, stainless steel. Each ferrule 25 includes a hole portion 26 that is connected to with the space in the liner 21. Further, the liner 21 includes a valve 27 and a screw 28. The valve 27 is attached to the hole portion 26 of the ferrule 25 located at a first end 21a in the axial direction of the liner 21. The screw 28 is threaded into the hole portion 26 of the ferrule 25 located at a second end 21b in the axial direction of the liner 21.

### Configuration of Fiber-Reinforced Base Member 22

As shown in FIGS. 2, 3, and 4, the fiber-reinforced base member 22 includes wefts 30, which are first yarns, and warps 31, which are second yarns. The wefts 30 are arranged such that the yarn main axes extend in the axial direction of the body portion 23. A direction in which the yarn main axes of the wefts 30 extend, that is, the yarn main axis direction of the wefts 30 is indicated by a reference symbol X1. The wefts 30 are arranged in a circumferential direction Z of the liner 21. The wefts 30 each include a portion extending straight along the outer circumferential surface of the body portion 23 and a portion extending in a curving manner along the outer circumferential surface of each dome portion 24. The cross-sectional shape of each weft 30 is flat. Each weft 30 is a fiber bundle composed of multiple reinforcement fibers that are continuous fibers. The reinforcement fibers are, for example, carbon fibers.

The warps 31 are arranged such that yarn main axes extend in the circumferential direction Z of the liner 21. The direction in which the yarn main axes of the warps 31 extend, i.e., the yarn main axis direction of the warps 31, is indicated by reference symbol X2. The warps 31 are arranged in the axial direction Y of the liner 21, and are disposed in the body portion 23 and the dome portions 24 so as to be parallel to each other. The cross-sectional shape of each warp 31 is flat. Each warp 31 is a fiber bundle composed of multiple reinforcement fibers that are continuous fibers. The reinforcement fibers are, for example, carbon fibers. The fiber-reinforced base member 22 is a woven fabric.

The wefts 30 and the warps 31 are arranged to be orthogonal to each other, and the yarn main axis direction X1 of the wefts 30 agrees with the axial direction Y of the liner 21. Thus, the liner 21 is reinforced in the axial direction Y. Since the yarn main axis direction X2 of the warps 31 agrees with the circumferential direction Z of the liner 21, the liner 21 is reinforced in the radial direction.

### Configuration of First Sections 40 and Second Sections 41

As shown in FIG. 1, the fiber-reinforced base member 22 includes two first sections 40 and three second sections 41. In order to cover at least the boundary R between the body portion 23 and the corresponding dome portion 24, each first section 40 extends across an end region of the dome portion 24 that is close to the boundary R and an end region of the body portion 23 that is close to the boundary R. The second sections 41 are sections excluding the first sections 40. Each first section 40 covers, from the outside, a portion of the liner 21 from a part of the body portion 23 to a part of the corresponding dome portion 24 across the corresponding boundary R. Specifically, each first section 40 covers, from the outside, an end region in the axial direction of the body portion 23 and a part of the first curved portion 24a of the dome portion 24. The first section 40 therefore extends between the corresponding shoulder portion A1 and the body portion 23 and covers the boundary R.

The second sections 41 include a linear portion 42 and two curved portions 43. The linear portion 42 covers, from the outside, a part of the body portion 23, specifically, an intermediate region in the axial direction of the body portion 23. The linear portion 42 connects the first sections 40 to each other. Each curved portion 43 covers a part of the first curved portion 24a, the entire second curved portion 24c, and the entire linear portion 24b from the outside.

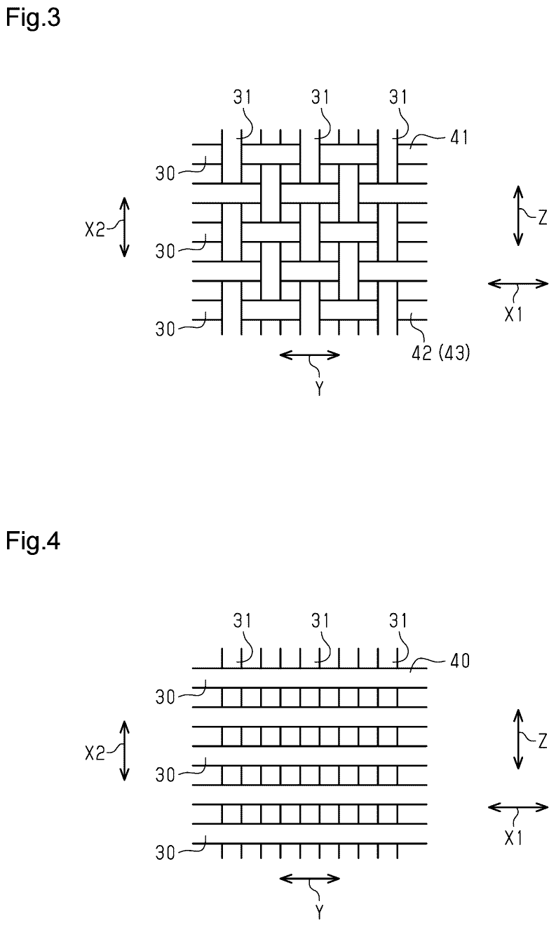

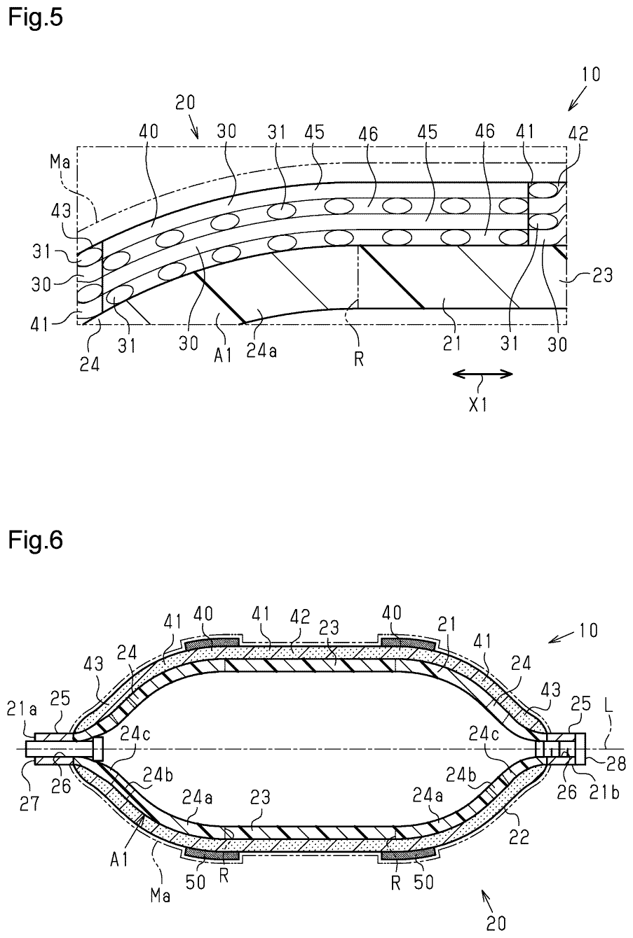

As shown in FIGS. 3 and 5, each second section 41 is formed by plain-weaving the wefts 30 and the warps 31. In the second section 41, the wefts 30 and the warps 31 are interlaced with each other.

As shown in FIGS. 4 and 5, each first section 40 is formed by stacking weft layers 45 formed by the wefts 30 and warp layers 46 formed by the warps 31. The average degree of interlacing between the wefts 30 and the warps 31 is lower in the first sections 40 than in the second sections 41. In the present embodiment, the wefts 30 and the warps 31 are not interlaced with each other in the first sections 40. The term “degree of interlacing” refers to the degree of interlacing between the wefts 30 and the warps 31. The term “interlacing” refers to a state in which the wefts 30 and the warps 31 cross each other at a right angle. The higher the degree of interlacing, the more interlaced the wefts 30 and the warps 31 are. The lower the degree of interlacing, the less interlaced the wefts 30 and the warps 31 are. The “average degree of interlacing” refers to the degree of interlacing per unit amount. In the present embodiment, the degree of interlacing of all the first sections 40 is constant.

The fiber-reinforced base member 22 of the present embodiment is woven by changing the manner in which the wefts 30 and the warps 31 are wound around the liner 21 between the first sections 40 and the second sections 41. As such, the structure of the fiber-reinforced base member 22 is different between the first sections 40 and the second sections 41.

### Operation of First Embodiment

Operation of the first embodiment will now be described.

For example, when the high-pressure tank 10 is filled with hydrogen gas, the internal pressure acts on the liner 21, so that a load is applied to the liner 21. Since the magnitude of the applied load and the direction of the applied load are different between the body portion 23 and the dome portions 24, the liner 21 is likely to be distorted at the boundaries R between the body portion 23 and the dome portions 24. Therefore, in the fiber-reinforced base member 22, each first section 40, which covers the portion of the liner 21 including a boundary R, is more likely to be affected by the distortion of the liner 21 than the second sections 41, which are sections excluding the first sections 40.

In this regard, in each first section 40, the average degree of interlacing between the wefts 30 and the warps 31 is lower than that in each second section 41 in the present embodiment. Therefore, in each first section 40, meandering of the wefts 30 and the warps 31 is likely to be suppressed. This increases the strength of the first sections 40, which are more likely to be affected by distortion of the liner 21 than the second sections 41. Accordingly, the strength of the fiber structure 20 is increased. As a result, even when the high-pressure tank 10 is filled with hydrogen gas, and the internal pressure acts on the liner 21, the high-pressure tank 10 is unlikely to be deformed.

### Advantages of First Embodiment

The first embodiment provides the following advantages.

(1-1) Since the magnitude of the applied load and the direction of the applied load are different between the body portion 23 and the dome portions 24, the liner 21 is likely to be distorted at the boundaries R between the body portion 23 and the dome portions 24. Therefore, in the fiber-reinforced base member 22, each first section 40, which covers the portion of the liner 21 including a boundary R, is more likely to be affected by the distortion of the liner 21 than the second sections 41, which are sections excluding the first sections 40. In this regard, in each first section 40, the average degree of interlacing between the wefts 30 and the warps 31 is lower than that in each second section 41. This suppresses meandering of the wefts 30 and the warps 31 in the first sections 40. Since this increases the strength of the first sections 40, which are more likely to be affected by distortion of the liner 21 than the second sections 41, the strength of the fiber structure 20 is increased. In order to increase the strength of the fiber structure 20, for example, the thickness of the entire fiber-reinforced base member 22 may be increased. In this case, the thickness of the second sections 41, which are less likely to be distorted than the first sections 40 and do not need to be increased in strength, is also increased unnecessarily. The present embodiment does not cause such an issue. As a result, the weight of the fiber structure 20 does not increase unnecessarily, and the manufacturing costs do not increase unnecessarily. As described above, it is possible to increase the strength of the fiber structure 20 while limiting an increase in the weight and the manufacturing costs.

(1-2) A fiber-reinforced base member 22 that is a woven fabric is suitable as the fiber-reinforced base member 22 for reinforcing the liner 21.

(1-3) The wefts 30 and the warps 31 are not interlaced with each other in the first sections 40. This configuration more readily suppresses meandering of the wefts 30 and the warps 31 in the first sections 40 than in a case in which the wefts 30 and the warps 31 are interlaced. Since this further increases the strength of the first sections 40, which are more likely to be affected by distortion of the liner 21 than the second sections 41, the strength of the fiber structure 20 is further increased.

### Second Embodiment

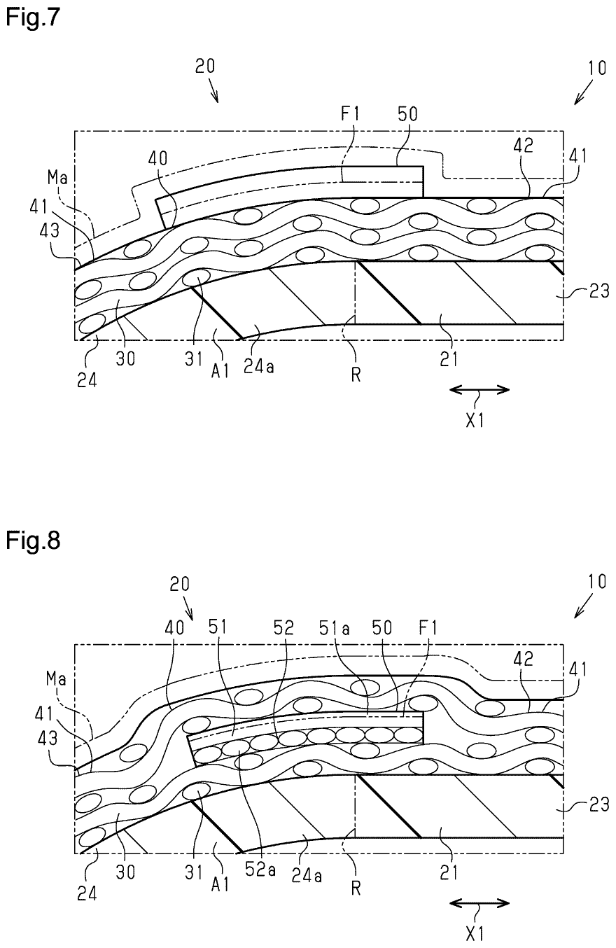

A second embodiment of the present disclosure will now be described with reference to FIGS. 6 and 7. In the embodiments described below, the same reference numerals are given to those components that are the same as the corresponding components of the first embodiment, which has already been described, and explanations are omitted or simplified.

As shown in FIGS. 6 and 7, each first section 40 is provided with a reinforcing member 50. Each reinforcing member 50 is a sheet of a unidirectional prepreg. Each reinforcing member 50 includes reinforcement fibers F1 arranged to extend in the axial direction of the body portion 23. FIG. 7 indicates hypothetical positions of the reinforcement fibers F1 with long-dash double-short-dash lines. The yarn main axes of the reinforcement fibers F1 extend in the axial direction of the body portion 23. Each reinforcing member 50 is wound around the outer circumferential surface of each first section 40.

In FIG. 7, the wefts 30 and the warps 31 are interlaced in the first section 40. However, the wefts 30 and the warps 31 do not necessarily need to be interlaced, as in the first embodiment.

### Operation of Second Embodiment

Operation of the second embodiment will now be described.

The first sections 40 are provided with the reinforcing members 50, which include the reinforcement fibers F1 arranged such that yarn main axes extend in the axial direction of the body portion 23. The reinforcing members 50 thus increase the strength of the first sections 40, which are more likely to be affected by distortion of the liner 21 than the second sections 41. Accordingly, the strength of the fiber structure 20 is increased. As a result, even when the high-pressure tank 10 is filled with hydrogen gas, and the internal pressure acts on the liner 21, the high-pressure tank 10 is unlikely to be deformed.

### Advantages of Second Embodiment

The second embodiment provides the following advantages.

(2-1) The first sections 40 are provided with the reinforcing members 50, which include the reinforcement fibers F1 arranged such that yarn main axes extend in the axial direction of the body portion 23. Since the reinforcing members 50 increase the strength of the first sections 40, which are more likely to be affected by distortion of the liner 21 than the second sections 41, the strength of the fiber structure 20 is increased. In order to increase the strength of the fiber structure 20, for example, the thickness of the entire fiber-reinforced base member 22 may be increased. In this case, the thickness of the second sections 41, which are less likely to be distorted than the first sections 40 and do not need to be increased in strength, is also increased unnecessarily. The present embodiment does not cause such an issue. As a result, the weight of the fiber structure 20 does not increase unnecessarily, and the manufacturing costs do not increase unnecessarily. As described above, it is possible to increase the strength of the fiber structure 20 while limiting an increase in the weight and the manufacturing costs.

(2-2) The reinforcing members 50, which are unidirectional prepregs, are suitable as a configuration for increasing the strength of the first sections 40.

### Modifications

The above-described embodiments may be modified as follows. The above-described embodiments and the following modifications can be combined as long as the combined modifications remain technically consistent with each other.

As shown in FIG. 8, the reinforcing member 50 may be embedded inside the first section 40, for example.

As shown in FIG. 8, the reinforcing member 50 may be a woven fabric. In this case, for example, the reinforcing member 50 may be formed by stacking a weft layer 51 formed by wefts 51a and a warp layer 52 formed by warps 52a. The reinforcement fibers F1, which form the wefts 30, are arranged such that the yarn main axes extend in the axial direction of the body portion 23. In other words, the reinforcing member 50 may be modified as long as it includes reinforcement fibers F1 arranged such that the yarn main axes extend in the axial direction of the body portion 23.

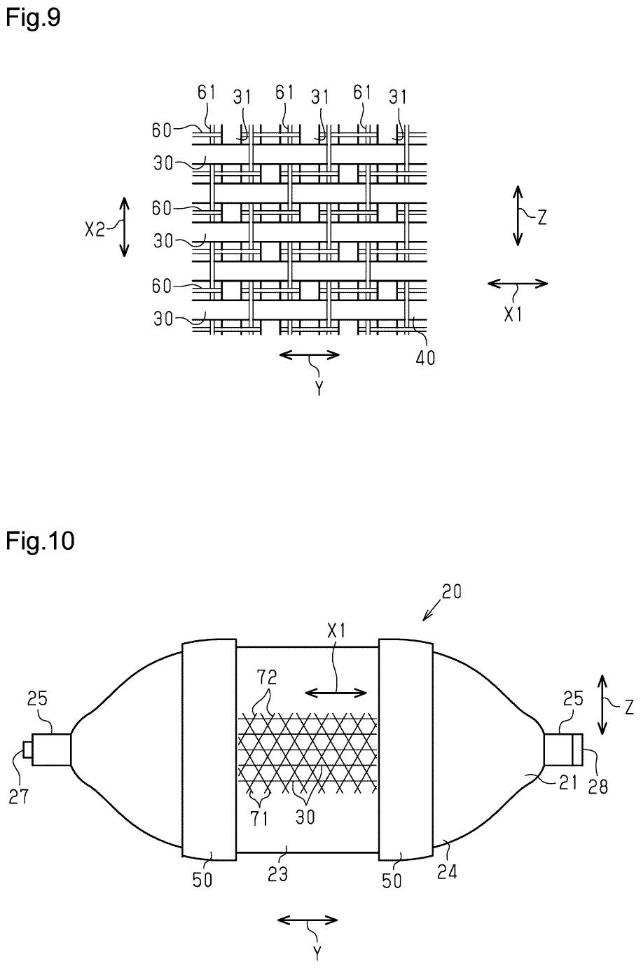

As shown in FIG. 9, each first section 40 may further include a first auxiliary yarns 60 and a second auxiliary yarns 61, which are auxiliary yarns interlaced with the wefts 30 and the warps 31.

This configuration ensures that even if the fiber-reinforced base member 22 is a woven fabric, the structural disintegration of the first section 40 is prevented by the first auxiliary yarns 60 and the second auxiliary yarns 61, which are interlaced with the wefts 30 and the warps 31. This further readily increases the strength of the first section 40.

Moreover, by placing the first auxiliary yarns 60 between the wefts 30 and placing the second auxiliary yarns 61 between the warps 31, gaps are more likely to form between the yarns of the fiber structure 20. Consequently, when impregnating the fiber structure 20 with the matrix resin Ma using, for example, the RTM method, the matrix resin Ma infiltrates through these gaps. Therefore, the fiber structure 20 is readily impregnated with the matrix resin Ma.

As shown in FIG. 10, in the second embodiment, the fiber-reinforced base member 22 may be a braided fabric. In this case, the fiber-reinforced base member 22 includes wefts 30, first inclined yarns 71, and second inclined yarns 72. The first inclined yarns 71 and second inclined yarns 72 are the second yarns of which the yarn main axes extend in the circumferential direction of the liner 21. The circumferential direction of the liner 21 includes not only the direction orthogonal to the axial direction of the liner 21, but also directions inclined in relation to the axial direction of the liner 21. The fiber-reinforced base member 22 that is a braided fabric is suitable as a configuration of the fiber-reinforced base member 22 that covers the liner 21 from the outside. In this case, the term “degree of interlacing” refers to the degree of interlacing of the wefts 30 with the first and second inclined yarns 71, 72. The term “interlacing” refers to a state in which the wefts 30 cross with the first and second inclined yarns 71, 72.

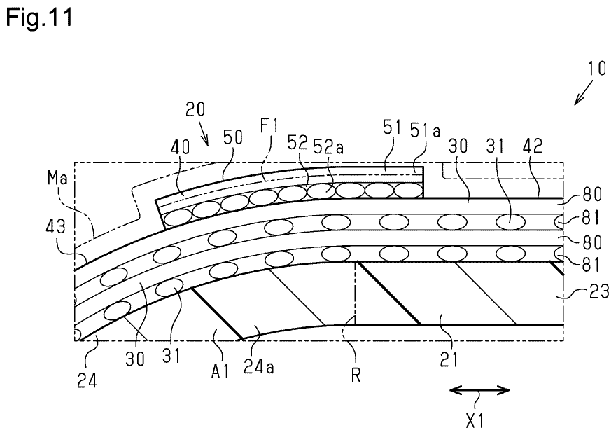

As shown in FIG. 11, in the second embodiment, the fiber-reinforced base member 22 may be formed by winding the wefts 30 and the warps 31 around the liner 21 by filament winding. In this case, the fiber-reinforced base member 22 includes weft-winding layers 80, in which the wefts 30 are wound by filament winding, and warp-winding layers 81, in which the warps 31 are wound by filament winding. The weft-winding layers 80 and the warp-winding layers 81 are disposed alternately. The reinforcing member 50 is disposed so as to be wound around the outer circumferential surface of the weft-winding layer 80 located at the outermost layer. The fiber-reinforced base member 22 formed by winding the wefts 30 and the warps 31 around the liner 21 by filament winding is suitable as a configuration of the fiber-reinforced base member 22 that covers the liner 21 from the outside.

In the first embodiment, each first section 40 may be provided with a reinforcing member.

In the first embodiment, the second sections 41 are formed by plain-weaving, but the present disclosure is not limited thereto. For example, the second sections 41 may be formed by twill weaving or multi-layer weaving. In other words, the weaving method of the fiber-reinforced base member 22 is not particularly limited.

In the first embodiment, the wefts 30 and the warps 31 may be interlaced in the first sections 40 as long as the average degree of interlacing between the wefts 30 and the warps 31 is lower in the first sections 40 than in the second sections 41. In other words, the average degree of interlacing in the first sections 40 between the wefts 30 and the warps 31 may be changed as long as it is lower than that in the second sections 41. Further, the degree of interlacing in the first sections 40 does not necessarily need to be constant. For example, the degree of interlacing in each first sections 40 may gradually decrease from the body portion 23 toward the corresponding dome portion 24, or may gradually increase from the body portion 23 toward the corresponding dome portion 24.

In each of the above-described embodiments, each second section 41 may lack the linear portion 42 and include only the two curved portions 43. In this case, the first sections 40 may extend between an end portion of one of the dome portions 24 that is close to the corresponding boundary R and an end portion of the other dome portion 24 that is close to the corresponding boundary R. That is, the first sections 40 may be provided not only in regions covering the boundaries R, but also in a region covering the entire body portion 23. In other words, the first sections 40 may be modified as long as the first sections 40 extend between each shoulder portion A1 and the body portion 23 so as to cover at least the boundary R between the body portion 23 and each dome portion 24.

In each of the above-described embodiments, each dome portion 24 does not necessarily include the linear portion 24b. In other words, each dome portion 24 may be formed by the first curved portion 24a and the second curved portion 24c. In this case, for example, the shoulder portion A1 may be modified as long as it extends from the boundary R to the boundary between the first curved portion 24a and the second curved portion 24c.

In each of the above-described embodiments, each dome portion 24 does not necessarily include the linear portion 24b and the second curved portion 24c. In other words, the dome portion 24 may include only by the first curved portion 24a. In this case, the shoulder portion A1 may be modified as long as it extends from the boundary R to the central portion of the first curved portion 24a.

In the above-described embodiments, the first curved portion 24a may occupy less than 50% of the dome portion 24. In other words, the first curved portion 24a may be modified as long as it is configured to be the shoulder portion A1.

In each of the above-described embodiments, the wefts 30 may fiber bundles formed by bundling of non-reinforcement fibers.

In each of the above-described embodiments, the warps 31 may fiber bundles formed by bundling of non-reinforcement fibers.

In each of the above-described embodiments, the reinforcement fibers forming the wefts 30 and the warps 31 are not limited to carbon fibers. The reinforcement fibers forming the wefts 30 and the warps 31 may be other fibers that are generally referred to as having high elasticity and high strength, such as glass fibers, silicon carbide-based ceramic fibers, aramid fibers, or ultra-high molecular weight polyethylene fibers.

In each of the above-described embodiments, the liner 21 is made of plastic. However, the present disclosure is not limited to this. The liner 21 may be made of, for example, aluminum.

In each of the above-described embodiments, the high-pressure tank 10 is not limited to a tank used as a hydrogen source mounted on a battery electric vehicle equipped with a fuel cell. The high-pressure tank 10 may be employed for a hydrogen source for a hydrogen engine or a heat pump. The high-pressure tank 10 may be used as a hydrogen source for a home fuel cell.

1. A fiber structure, comprising:
a liner that includes:
a cylindrical body portion;
a dome portion that is continuous with the body portion in an axial direction in which a central axis of the body portion extends, the dome portion having a shape tapering toward the central axis; and
a shoulder portion that is a part of the dome portion and is an area adjacent to the body portion; and
a fiber-reinforced base member covering the liner from outside, wherein
the fiber-reinforced base member includes:
first yarns arranged such that yarn main axes of the first yarns extend in the axial direction; and
second yarns arranged such that yarn main axes of the second yarns extend in a circumferential direction of the liner,
the fiber-reinforced base member includes:
a first section extending between the shoulder portion and the body portion so as to cover at least a boundary between the body portion and the dome portion; and
a second section that is a section excluding the first section, and
an average degree of interlacing between the first yarns and the second yarns is lower in the first section than in the second section.

2. The fiber structure according to claim 1, wherein the first section is provided with a reinforcing member including reinforcement fibers arranged such that yarn main axes of the reinforcement fibers extend in the axial direction.

3. The fiber structure according to claim 2, wherein the reinforcing member is a woven fabric.

4. The fiber structure according to claim 2, wherein the reinforcing member is a unidirectional prepreg.

5. The fiber structure according to claim 1, wherein the fiber-reinforced base member is a woven fabric.

6. The fiber structure according to claim 2, wherein the fiber-reinforced base member is a braided fabric.

7. The fiber structure according to claim 2, wherein the fiber-reinforced base member is formed by winding the first yarns and the second yarns around the liner by filament winding.

8. The fiber structure according to claim 5, wherein the first yarns and the seconds yarn are not interlaced in the first section.

9. The fiber structure according to claim 5, wherein the first section further includes auxiliary yarns that are interlaced with the first yarns and the second yarns.

10. The fiber structure according to claim 1, wherein the second section covers the dome portion except for at least a portion of the shoulder portion covered by the first section.
